(19) United States
(12) Patent Application Publication
(10) Pub. No.: US 2025/0193265 A1
(43) Pub. Date: Jun. 12, 2025

(54) DATA TRANSMISSION METHOD, DATA PROCESSING METHOD, APPARATUSES, DEVICE, AND STORAGE MEDIUM

(71) Applicant: Beijing Volcano Engine Technology Co., Ltd., Beijing (CN)

(72) Inventors: Ruili FANG, Beijing (CN); Xiaofei PANG, Beijing (CN)

(21) Appl. No.: 18/949,369

(22) Filed: Nov. 15, 2024

(30) Foreign Application Priority Data
Dec. 6, 2023 (CN) 202311669481.0

(51) Int. Cl. H04L 65/70; H04L 47/34

(52) U.S. Cl. CPC H04L 65/70; H04L 47/34

(57) ABSTRACT

Embodiments of the present disclosure provide a data transmission method, a data processing method, apparatuses, a device, and a storage medium. The data transmission method includes: acquiring a current frame identifier of a current data frame in a target data stream, where the current data frame is a data frame that is currently to be sent; generating a current relationship sequence of the current data frame according to the current frame identifier and a historical frame identifier of at least one historical data frame, where the current data frame and the at least one historical data frame are data frames continuously arranged in the target data stream, and the current relationship sequence is used to indicate a current arrangement sequence of the current data frame in the target data stream; and transmitting frame data of the current data frame and the current relationship sequence to a receiving end.

### CROSS-REFERENCE TO RELATED APPLICATION(S)

This application claims priority to Chinese Application No. 202311669481.0 filed Dec. 6, 2023, the disclosure of which is incorporated herein by reference in its entity.

### FIELD

Embodiments of the present disclosure relate to the field of computer technology, and in particular, to a data transmission method, a data processing method, apparatuses, a device, and a storage medium.

### BACKGROUND

Currently, when live stream pull is performed based on peer to peer (P2P), data streams are uniformly sliced through a server or a central node, and slice data is continuously and incrementally labeled for transmission control. However, the solution for live stream pull based on the P2P in the prior art is relatively complex and has poor disaster recovery capabilities.

### SUMMARY

Embodiments of the present disclosure provide a data transmission method, a data processing method, apparatuses, a device, and a storage medium, so as to simplify a solution of P2P-based live stream pull, and improve the disaster recovery capability of the live stream pull.

In a first aspect, an embodiment of the present disclosure provides a data transmission method, applied to a transmitting end. The method includes:
acquiring a current frame identifier of a current data frame in a target data stream, where the current data frame is a data frame that is currently to be sent;
generating a current relationship sequence of the current data frame according to the current frame identifier and a historical frame identifier of at least one historical data frame, where the current data frame and the at least one historical data frame are data frames continuously arranged in the target data stream, and the current relationship sequence is used to indicate a current arrangement sequence of the current data frame in the target data stream; and
transmitting frame data of the current data frame and the current relationship sequence to a receiving end.

In a second aspect, an embodiment of the present disclosure further provides a data processing method, applied to a receiving end. The method includes:
receiving a current relationship sequence of a current data frame and acquiring frame data of the current data frame, where the current relationship sequence is sent by a first transmitting end, includes a current frame identifier of the current data frame and a historical frame identifier of at least one historical data frame, and is used to indicate a current arrangement sequence of the current data frame in a target data stream, and the current data frame and the at least one historical data frame are data frames continuously arranged in the target data stream; and
adding the frame data of the current data frame to the target data stream based on the current arrangement sequence.

In a third aspect, an embodiment of the present disclosure further provides a data transmission apparatus, configured at a transmitting end. The apparatus includes:
an acquiring module, configured to acquire a current frame identifier of a current data frame in a target data stream, where the current data frame is a data frame that is currently to be sent;
a generation module, configured to generate a current relationship sequence of the current data frame according to the current frame identifier and a historical frame identifier of at least one historical data frame, where the current data frame and the at least one historical data frame are data frames continuously arranged in the target data stream, and the current relationship sequence is used to indicate a current arrangement sequence of the current data frame in the target data stream; and
a transmitting module, configured to transmit frame data of the current data frame and the current relationship sequence to a receiving end.

In a fourth aspect, an embodiment of the present disclosure further provides a data processing apparatus, configured at a receiving end. The apparatus includes:
a receiving module, configured to receive a current relationship sequence of a current data frame and acquire frame data of the current data frame, where the current relationship sequence is sent by a first transmitting end and includes a current frame identifier of the current data frame and a historical frame identifier of at least one historical data frame, the current relationship sequence is used to indicate a current arrangement sequence of the current data frame in a target data stream, and the current data frame and the at least one historical data frame are data frames continuously arranged in the target data stream; and
a first adding module, configured to add the frame data of the current data frame to the target data stream based on the current arrangement sequence.

In a fifth aspect, an embodiment of the present disclosure further provides an electronic device, including:
one or more processors; and
a memory, configured to store one or more programs, where
the one or more programs, when executed by the one or more processors, cause the one or more processors to implement the data transmission method or the data processing method according to the embodiments of the present disclosure.

In a sixth aspect, an embodiment of the present disclosure further provides a computer-readable storage medium, storing a computer program, where the program, when executed by a processor, implements the data transmission method or the data processing method according to the embodiments of the present disclosure.

### BRIEF DESCRIPTION OF THE DRAWINGS

The above and other features, advantages, and aspects of various embodiments of the present disclosure will become more apparent with reference to the accompanying drawings and the following specific implementations. Throughout the accompanying drawings, the same or similar reference numerals denote the same or similar elements. It should be understood that the accompanying drawings are illustrative, and components and elements may not necessarily be drawn to scale.

FIG. 1 is a schematic flowchart of a data transmission method according to an embodiment of the present disclosure;

FIG. 2 is a schematic flowchart of another data transmission method according to an embodiment of the present disclosure;

FIG. 3 is a schematic diagram of a generation method of a relationship sequence according to an embodiment of the present disclosure;

FIG. 4 is a schematic flowchart of a data processing method according to an embodiment of the present disclosure;

FIG. 5 is a block diagram of a structure of a data transmission apparatus according to an embodiment of the present disclosure; and

FIG. 6 is a block diagram of a structure of a data processing apparatus according to an embodiment of the present disclosure; and

FIG. 7 is a schematic diagram of a structure of an electronic device according to an embodiment of the present disclosure.

### DETAILED DESCRIPTION OF EMBODIMENTS

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

It should be understood that the steps recorded in the method implementations of the present disclosure may be performed in different sequences and/or in parallel. Further, additional steps may be included and/or the execution of the illustrated steps may be omitted in the method implementations. The scope of the present disclosure is not limited in this aspect.

The term “including” used herein and variations thereof are open-ended inclusions, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the sequence or relation of interdependence of functions performed by these apparatuses, modules, or units.

It should be noted that the modifiers “one” and “a plurality of” mentioned in the present disclosure are illustrative and not restrictive, and those skilled in the art should understand that unless otherwise explicitly specified in the context, the modifiers should be understood as “one or more”.

The names of messages or information exchanged between a plurality of apparatuses in the implementations of the present disclosure are used for illustrative purposes only, and are not used to limit the scope of these messages or information.

It should be understood that before the use of the technical solutions disclosed in the embodiments of the present disclosure, a user shall be informed of the type, range of use, use scenarios, etc., of personal information involved in the present disclosure in an appropriate manner in accordance with relevant laws and regulations, and the authorization of the user shall be obtained.

The embodiments of the present disclosure provide the data transmission method, the data processing method, the apparatuses, the device, and the storage medium. The data transmission method includes: acquiring the current frame identifier of the current data frame in the target data stream, where the current data frame is the data frame that is currently to be sent; generating the current relationship sequence of the current data frame according to the current frame identifier and the historical frame identifier of the at least one historical data frame, where the current data frame and the at least one historical data frame are the data frames continuously arranged in the target data stream, and the current relationship sequence is used to indicate the current arrangement sequence of the current data frame in the target data stream; and transmitting the frame data of the current data frame and the current relationship sequence to the receiving end. The data processing method includes: receiving the current relationship sequence of the current data frame and acquiring the frame data of the current data frame, where the current relationship sequence is sent by the first transmitting end, includes the current frame identifier of the current data frame and the historical frame identifier of the at least one historical data frame, and is used to indicate the current arrangement sequence of the current data frame in the target data stream, and the current data frame and the at least one historical data frame are data frames continuously arranged in the target data stream; and adding the frame data of the current data frame to the target data stream based on the current arrangement sequence. By utilizing the above technical solution in the embodiments of the present disclosure, the relationship sequence indicates the arrangement sequence of the data frame in the data stream without marking the sequence through a central node, and therefore there is no need to set the central node for marking the sequence, thereby simplifying a P2P-based stream pull method, and improving the disaster recovery capability during stream pull.

For example, in response to reception of an active request from the user, a prompt message is sent to the user to clearly inform the user that a requested operation will require access to and use of the personal information of the user. As such, the user can independently choose, based on the prompt message, whether to provide the personal information to software or hardware, such as an electronic device, an application, a server, or a storage medium, that performs the operations of the technical solutions of the present disclosure.

As an optional but non-limiting implementation, in response to the reception of the active request from the user, the method for transmitting the prompt message to the user may be, for example, a pop-up window, in which the prompt message may be presented in text. Further, the pop-up window may also carry a selection control for the user to choose whether to “agree” or “disagree” to provide the personal information to the electronic device.

It should be understood that the above notification and user authorization obtaining process is only illustrative, which does not limit the implementations of the present disclosure, and other methods that comply with the relevant laws and regulations may also be applied to the implementations of the present disclosure.

It should be understood that data (including but not limited to the data itself, and data acquisition, or usage) involved in the technical solutions should comply with the requirements of the corresponding laws and regulations, and relevant stipulations.

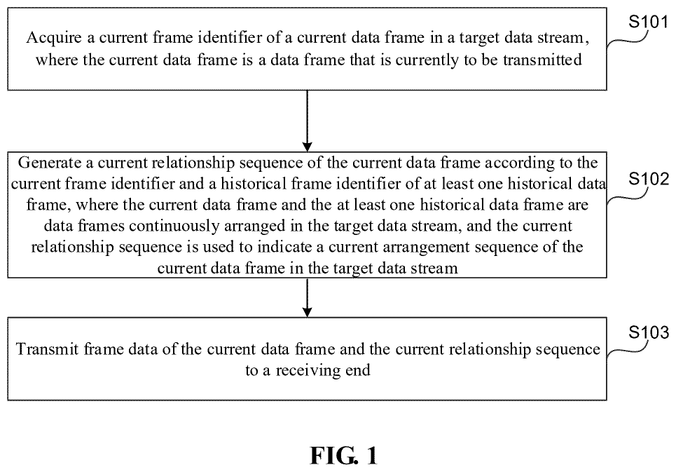

FIG. 1 is a schematic flowchart of a data transmission method according to an embodiment of the present disclosure. The method may be performed by a transmitting end, such as a data transmission apparatus. The apparatus may be implemented by software and/or hardware, may be configured in an electronic device, and typically, may be configured in a mobile phone or a tablet personal computer. The data transmission method provided in this embodiment of the present disclosure is suitable for a scenario of transmitting data to a receiving end, such as a scenario of transmitting data to the receiving end based on P2P.

Currently, in the industry, when implementing P2P-based stream pull for live stream flash video (FLV), a “central node” method is commonly used for uniform “slice”. The P2P requires the central node to slice and mark with consecutive increments for transmission protocol control. However, this method lays the groundwork for substantial future work and presents the problem about stability. For example, the entire network needs to maintain the unique central node for slice marking. When the network or stability of the central node is abnormal, seamless switching is needed, difficulty is extremely large, and the range of influence is wide. In addition, the P2P has an additional main function of emergency disaster recovery besides cost saving. For example, for an emergency large activity, a conventional content delivery network (CDN) may have the problems of insufficient bandwidth resource reserves or resource waste due to excessive reserves. The P2P, on the other hand, generally benefits from more nodes and greater system stability during larger activities. However, if the system has the central node, the greater the capacity is, the greater the risk becomes, which significantly compromises the effect of disaster recovery.

Further, due to the absence of an algorithm to restore multi-path data into a complete stream, only a single stream can be pulled through conventional FLV stream pull, failing in pull streaming from a plurality of places. The anti-jitter capability can only be deeply explored on a single link, failing to well utilize the advantages of a plurality of streams or exits, which limits the timely switch to reduce network impact and improve transmission quality.

To solve the problem about potential function expansion of the above FLV stream pull, an embodiment of the present disclosure provides a data transmission method, which can allow the FLV stream pull to support multi-path concurrent multiplexing without relying on the central node across the network, thereby simplifying a solution of P2P-based live stream pull, and improving the disaster recovery capability of the live stream pull.

As shown in FIG. 1, the data transmission method provided in this embodiment may include:

S101: Acquire a current frame identifier of a current data frame in a target data stream, where the current data frame is a data frame that is currently to be sent.

The target data stream may be understood as a complete data stream to be currently pulled by the receiving end. Optionally, the target data stream includes at least two data substreams, and the different data substreams are transmitted to the receiving end via different transmitting ends.

The receiving end and the transmitting end may be nodes in a P2P network. Taking a live stream scenario as an example, nodes in the P2P network may be terminal devices that use the P2P network to receive and send live data streams. In other words, the terminal devices that use the P2P network to receive or send live streams may all be referred to as the nodes in the P2P network. The receiving end may be a user side that currently uses the P2P network to receive data, such as a terminal device or a client that uses the P2P network to receive data. The transmitting end may be a user side that currently uses the P2P network to send data to the receiving end, such as a terminal device or a client that uses the P2P network to send data. The data stream type of the target data stream is not limited. For example, the target data stream may include a video stream and/or an audio stream. In the live stream scenario, the target data stream may be the live stream.

The target data stream may include a plurality of data substreams, and the different data substreams may be sent to the receiving end via different transmitting ends in the P2P network. In other words, the receiving end may pull different data substreams of the target data stream from a plurality of nodes in the P2P network and restore the target data stream based on the received data substreams. The different data substreams may include different data frames in the target data stream, such that the different transmitting ends may be used to send the different data frames in the target data stream to the receiving end. A method for dividing the data frames in the target data stream into the data substreams may be set as needed. Exemplarily, the data frames may be divided into the substreams based on decode time stamp (DTS) information of the data frames. For example, modular arithmetic, namely mod (DTS, max) may be performed according to the DTS of the data frames so as to perform substream division. In this case, optionally, a data substream corresponding to the current data frame is determined based on the decode time stamp information of the current data frame.

The current data frame may be understood as a data frame that is currently to be sent from the transmitting end to the receiving end, such as a data frame in the data substream corresponding to the current transmitting end that is currently to be sent to the receiving end. The current transmitting end may be any transmitting end that sends data to the receiving end based on the P2P network. The data frame may include, for example, a video frame and/or an audio frame, which is not limited in this embodiment. The current frame identifier may be understood as a frame identifier of the current data frame. A frame identifier of a certain data frame (e.g., the current data frame/and or a historical data frame) may be used to uniquely identify the data frame. Exemplarily, the frame identifier of the data frame may be a unique identify document (ID) for the data frame.

Specifically, the transmitting end may transmit, based on its corresponding data substream, frame data of a data frame in the corresponding data substream to the receiving end.

Exemplarily, when the transmitting end transmits the frame data of a certain data frame (i.e., the current data frame) in the data substream to the receiving end, the frame identifier of the data frame may be first acquired. For example, when the transmitting end has stored the frame identifier of the data frame, the stored frame identifier may be acquired; and when the transmitting end does not store the frame identifier of the data frame, a frame identifier of the data frame may be generated.

In this embodiment, the transmitting end may generate the frame identifier of the data frame that is sent by the transmitting end. A method for generating a frame identifier of a data frame is not limited. For example, the frame identifier of the data frame may be generated based on frame header information, a data portion, and/or slice count information of the data frame, as long as the data frame can be uniquely identified. The data frame (Tag) typically may include a frame header (TagHead), a data portion (TagData), and/or frame size information (TagSize).

In some implementations, since the frame header information of the data frame typically includes only a few bytes, the frame identifier of the data frame may be generated according to the frame header information of the data frame, such as generating the frame identifier of the data frame based on at least some fields in the frame header information of the data frame, thereby reducing the performance overhead when generating the frame identifier of the data frame and avoiding a new burden on the transmitting end on the premise of ensuring the accurate record of an arrangement sequence of the data frame in the target data stream. In this case, optionally, the step of acquiring a current frame identifier of a current data frame in a target data stream includes: acquiring current frame header information of the current data frame in the target data stream; and generating the current frame identifier of the current data frame according to the current frame header information. The current frame header information may be understood as the frame header information of the current data frame, such as field values of at least some fields in the current data frame, which may be acquired from the current data frame.

S102: Generate a current relationship sequence of the current data frame according to the current frame identifier and a historical frame identifier of at least one historical data frame, where the current data frame and the at least one historical data frame are data frames continuously arranged in the target data stream, and the current relationship sequence is used to indicate a current arrangement sequence of the current data frame in the target data stream.

The historical data frame may be a data frame located in front of the current data frame in the target data stream. The historical data frame may be a data frame sent by the current transmitting end to the receiving end, or may be a data frame sent by a transmitting end other than the current transmitting end to the receiving end, which is not limited in this embodiment. The at least one historical data frame and the current data frame are continuously arranged in the target data stream. In other words, the at least one historical data frame and the current data frame are data frames continuously arranged in the target data stream. The number of historical data frames used to generate the current relationship sequence may be preset as needed. For example, the number of the historical data frames may be set as 1, 2, 3, or the like. Taking two historical data frames as an example below, in this case, the current relationship sequence may be generated based on the frame identifier of the current data frame, a frame identifier of a first historical data frame that is located in front of and adjacent to the current data frame in the target data stream, and a frame identifier of a second historical data frame that is located in front of and adjacent to the first historical data frame in the target data stream.

The current relationship sequence may be a relationship sequence of the current data frame. A relationship sequence of a certain data frame (including the current data frame) may be used to indicate an arrangement sequence of the data frame in the target data stream. The relationship sequence may include the frame identifier of the data frame, as well as a frame identifier of at least one data frame in a segment of data frames that are located in front of the data frame in the target data stream and are continuously arranged with the data frame. Each frame identifier in the relationship sequence of the data frame may be arranged according to an arrangement sequence of a corresponding data frame in the target data stream. Taking the current relationship sequence as an example, the current relationship sequence may include the current frame identifier and the historical frame identifier of the at least one historical data frame. The current frame identifier and the historical frame identifier may be arranged according to the arrangement sequence of the corresponding data frame in the target data stream.

The historical frame identifier may be understood as the frame identifier of the historical data frame. The current arrangement sequence may be understood as an arrangement sequence of the current data frame in the target data stream.

In this embodiment, after acquiring the current frame identifier of the current data frame, the relationship sequence of the current data frame may be generated based on the current frame identifier and the frame identifier of the at least one historical data frame for the current data frame, namely generating the current relationship sequence, thereby indicating the arrangement sequence of the current data frame in the target data stream according to the current relationship sequence.

Exemplarily, after acquiring the current frame identifier, the current frame identifier and the historical frame identifier of the at least one historical data frame may be arranged according to the arrangement sequence of the current data frame and the at least one historical data frame in the target data stream, thereby obtaining the current relationship sequence of the current data frame.

Additionally, in a relationship sequence of a certain data frame, different frame identifiers may be directly concatenated, or may be spaced through preset characters or lines, such as connecting the different frame identifiers through a connecting line. Exemplarily, the connecting line may point from the frame identifier of the preceding data frame to the frame identifier of the following data frame among two adjacent data frame according to the arrangement sequence of the data frames in the target data stream.

S103: Transmit frame data of the current data frame and the current relationship sequence to the receiving end.

Exemplarily, after generating the current relationship sequence of the current data frame, the current relationship sequence and the frame data of the current data frame may be sent to the receiving end. That is, when the frame data of the current data frame is sent to the receiving end, the relationship sequence of the current data frame is further sent to the receiving end, such that the receiving end determines, based on the relationship sequence of the current data frame, the arrangement sequence of the current data frame in the target data stream. The frame data of the current data frame may be data of the current data frame that is to be sent to the receiving end, which may include some of the data in the current data frame.

In some implementations, before the step of transmitting frame data of the current data frame and the current relationship sequence to the receiving end, the method further includes: using a preset slice method to slice the frame data of the current data frame to obtain slice data of the current data frame, where the preset slice method is a slice method shared by different transmitting ends. The step of transmitting frame data of the current data frame and the current relationship sequence to the receiving end includes: transmitting slice data of the current data frame and the current relationship sequence to the receiving end.

The slice data of the current data frame may be data obtained after slicing the frame data of the current data frame, and the frame data of the current data frame may be sliced into a plurality of slice data. The preset slice method may be a pre-set slice method. Exemplarily, in the preset slice method, the slice size of the data frame may be indicated, namely, a maximum transmission unit (MTU), such as indicating the size by which the data frame is sliced. The preset slice method may be a slice method shared by different transmitting ends. In other words, the transmitting ends may slice, based on the preset slice method, the data frame to be sent, thereby ensuring that the receiving end may concatenate, based on the same concatenation method, the slice data of the data frame that is sent by the different transmitting ends. The maximum transmission unit may be set as needed, which is not limited in this embodiment.

In the above implementation, the current data frame may be sliced, and the slice data obtained after slice processing is sent to the receiving end.

Specifically, the frame data of the current data frame may be sliced according to the preset slice method before, after, or during acquiring the frame identifier of the current data frame, or before, after, or during generating the current relationship sequence, to obtain the slice data of the current data frame. Therefore, after obtaining the slice data of the current data frame and the current relationship sequence of the current data frame, the slice data of the current data frame and the current relationship sequence of the current data frame may be sent to the receiving end.

According to the data transmission method provided in this embodiment, the current frame identifier of the current data frame in the target data stream is acquired, and the current data frame is the data frame that is currently to be sent; the current relationship sequence of the current data frame is generated according to the current frame identifier and the historical frame identifier of the at least one historical data frame, where the current data frame and the at least one historical data frame are the data frames continuously arranged in the target data stream, and the current relationship sequence is used to indicate the current arrangement sequence of the current data frame in the target data stream; and the frame data of the current data frame and the current relationship sequence are transmitted to the receiving end. By utilizing the above technical solution in this embodiment, when the frame data of the data frame is sent to the receiving end, the relationship sequence of the data frame is further sent and indicates the arrangement sequence of the data frame in the data stream without marking the sequence through the central node, and therefore there is no need to set the central node for marking the sequence, thereby simplifying a P2P-based stream pull method, and improving the disaster recovery capability during stream pull.

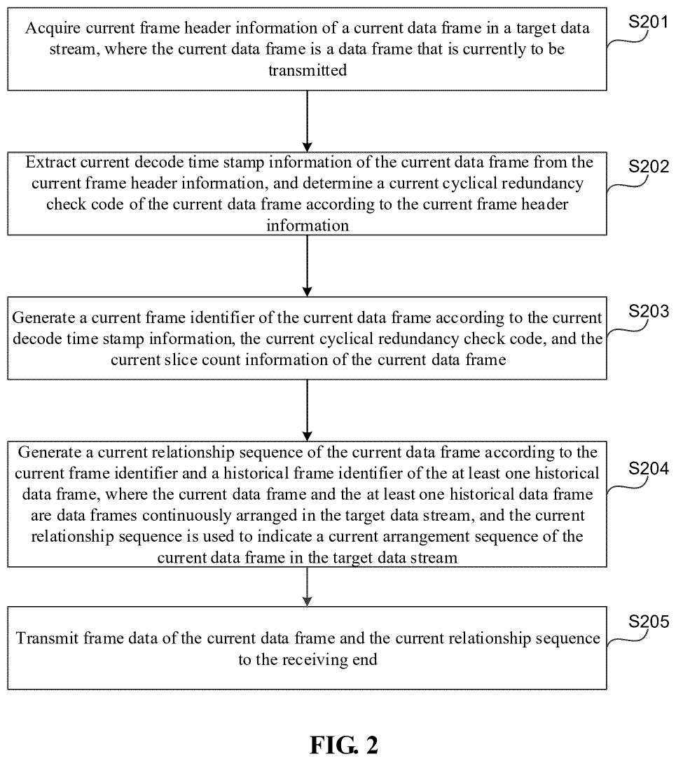

FIG. 2 is a schematic flowchart of another data transmission method according to an embodiment of the present disclosure. The solution in this embodiment may be combined with one or more optional solutions in the above embodiment. Optionally, the generating the current frame identifier of the current data frame according to the current frame header information includes: extracting current decode time stamp information of the current data frame from the current frame header information; determining a current cyclical redundancy check code of the current data frame according to the current frame header information; and generating a current frame identifier of the current data frame based on the current decode time stamp information, the current cyclical redundancy check code, and current slice count information of the current data frame.

Correspondingly, as shown in FIG. 2, the data transmission method provided in this embodiment may include:

S201: Acquire current frame header information of a current data frame in a target data stream, where the current data frame is a data frame that is currently to be sent.

S202: Extract current decode time stamp information of the current data frame from the current frame header information, and determine a current cyclical redundancy check code of the current data frame according to the current frame header information.

The current decode time stamp information may be understood as decode time stamp information of the current data frame. The current cyclical redundancy check code may be understood as a cyclical redundancy check code of the current data frame.

In some embodiments, a frame identifier of a data frame may be composed of three parts including DTS information, a cyclic redundancy check (CRC) code, and slice count (CNT) information. Therefore, when generating the frame identifier of the current data frame, the DTS information, the CRC, and the CNT of the current data frame may be acquired. The slice count information of the data frame may be used to indicate how many slices the data frame is sliced based on the MTU.

Exemplarily, there may be a DTS field in the frame header information of the data frame, such that a field value of the DTS field may be extracted from the current frame header information of the current data frame as the current decode time stamp information of the current data frame. A CRC of the current data frame may be determined based on the frame header information of the current data frame.

In some implementations, when determining the CRC of the current data frame, frame header information of a historical data frame may not be considered, and the CRC of the current data frame may be determined only according to the frame header information of the current data frame.

In some other implementations, when determining the CRC of the current data frame, frame header information of a historical data frame may be considered, meanwhile, the CRC of the current data frame is generated based on the frame header information of the current data frame and the frame header information of the historical data frame, such that the generated frame identifier of the current data frame carries contextual information of the current data frame, and therefore, when frame identifiers generated by different transmitting ends for the same data frame are consistent, it may be determined that a contextual relationship of the data frame is also consistent, thereby facilitating a receiving end to determine whether a received relationship chain is accurate or not. In this case, optionally, the step of determining a cyclical redundancy check code of the current data frame according to the current frame header information includes: determining the cyclical redundancy check code of the current data frame according to the current frame header information and the historical frame header information of the at least one historical data frame. For example, a CRC hash operation may be performed on the current frame header information and the historical frame header information of the at least one historical data frame, thereby obtaining the CRC of the current data frame. The historical frame header information may be understood as frame header information of a historical data frame.

S203: Generate a current frame identifier of the current data frame according to the current decode time stamp information, the current cyclical redundancy check code, and the current slice count information of the current data frame.

The current slice count information may be understood as slice count information of the current data frame, which may be determined according to how many slices the data frame is sliced based on the MTU.

Specifically, after acquiring the DTS, the CRC, and the CNT of the current data frame, the current frame identifier of the current data frame may be generated based on the DTS, the CRC, and the CNT of the current data frame. For example, the DTS, the CRC, and the CNT of the current data frame may be concatenated according to a preset sequence to form one ID as the current frame identifier of the current data frame. The preset sequence is not limited. Exemplarily, the preset sequence may be: DTS-CRC-CNT.

S204: Generate a current relationship sequence of the current data frame according to the current frame identifier and a historical frame identifier of the at least one historical data frame, where the current data frame and the at least one historical data frame are data frames continuously arranged in the target data stream, and the current relationship sequence is used to indicate a current arrangement sequence of the current data frame in the target data stream. S205: Transmit frame data of the current data frame and the current relationship sequence to the receiving end.

According to the data transmission method provided in this embodiment, the frame identifier of the data frame is generated according to the decode time stamp information, the cyclical redundancy check code, and the slice count information of the data frame, thereby further reducing resources occupied by the generation of the frame identifier, and reducing the performance overhead when the transmitting end generates the frame identifier.

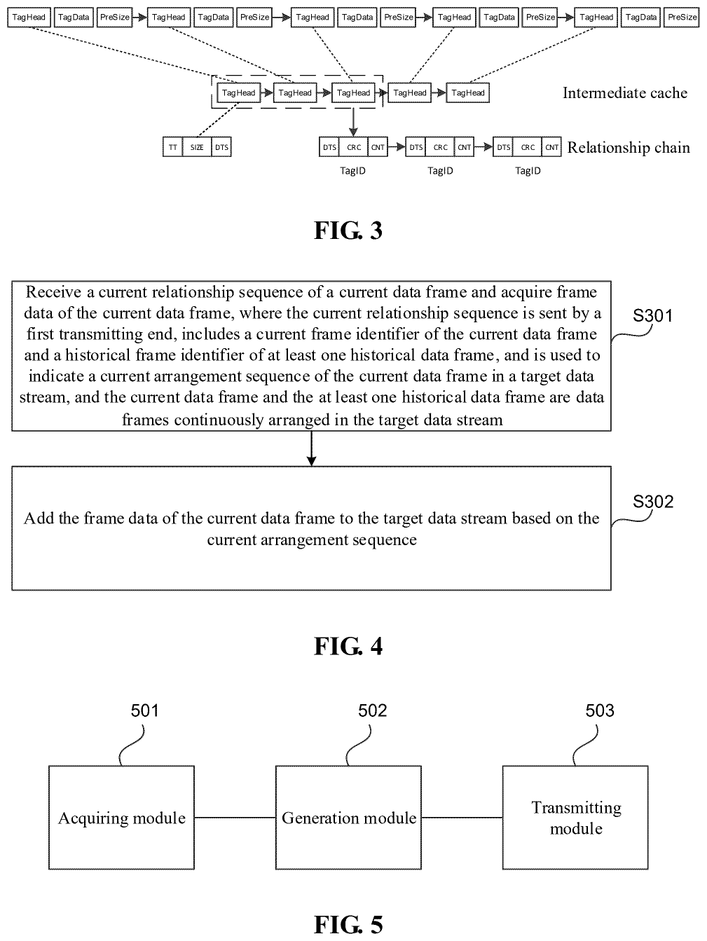

FIG. 3 is a schematic diagram of a generation method of a relationship sequence according to an embodiment of the present disclosure. Taking the example of P2P-based live stream pull based on the FLV protocol with a relationship chain (i.e., the relationship sequence) including frame identifiers of two historical data frames, exemplarily, the relevant content of the data transmission method provided in this embodiment may be described as follows:

Each Tag (i.e., the data frame) in the FLV protocol is mainly divided into three parts: TagHead, TagData, and PreSize. The TagHead may include information such as the type of a data frame (e.g., a TT field shown in FIG. 3), the size of the TagHead (e.g., a SIZE field shown in FIG. 3), and/or a DTS of the data frame. In this embodiment, when the relationship chain is generated, on one hand, an FLV audio and video sequence can be accurately and completely recorded, and on the other hand, the algorithm performance overhead is low enough, thereby avoiding new burdens.

Exemplarily, when generating the relationship chain, ID information (i.e., a frame identifier) of each Tag may be first generated, and is unique. The TagID (i.e., the frame identifier) is mainly composed of three parts: a DTS (DTS information of the Tag), CRC (a CRC value corresponding to the Tag), and a CNT (the number of slices the Tag is divided into according to the MTU). A CRC calculation method may be, for example, crc_hash (previous-previous TagHead, previous TagHead, and current TagHead). The current TagHead may be understood as TagHead of a current data frame, the previous TagHead may be understood as TagHead of a data frame preceding the current data frame in a live stream (i.e., the target data stream), and the previous-previous TagHead may be understood as a data frame preceding the previous data frame in the live stream.

After each Tag has its own TagID, the sequence of these TagIDs forms the relationship chain. When transmitting data, the transmitting end may send the relationship chain along with the data to the receiving end.

Additionally, with the relationship chain, the FLV protocol may, for example, perform modular arithmetic (modDTS, max) based on the tagDTS for substream division, thereby transmitting the substreams along with the relationship chain. When receiving multi-path substream data, the receiving end may receive a plurality of relationship chains, and concatenate the received relationship chains for each substream to obtain a complete relationship chain of the live stream, thereby obtaining the complete relationship chain corresponding to each of the plurality of substreams. The FLV live stream may be restored through the relationship chain. When there is an inconsistent bifurcation in the relationship chains corresponding to the plurality of substreams, the relationship chain received first may be taken as the reference, and each relationship chain is an observed result and has correctness. Each link in the relationship chain fitting together indicates consistency and identity in all previous historical links.

According to the data transmission method provided in this embodiment, the FLV stream pull may support multi-path stream pull, without requiring a central node to assign continuous sequence labels. Moreover, an audio and video stream may be completely restored without causing the abnormality of screen distortion, meanwhile, stability is improved, and the subsequent system workload is greatly reduced. Therefore, the data transmission method provided in this embodiment may greatly simplify the P2P solution, and reduce the manpower required, comparable to that of a CDN team, resulting in a more simple and stable system. The disaster recovery function of a mobile phone P2P may be truly and thoroughly achieved. Additionally, the conventional FLV single-stream pull is improved into multi-stream parallel pull and multi-exit stream pull, thereby further enhancing flexibility and network transmission quality.

FIG. 4 is a schematic flowchart of a data processing method according to an embodiment of the present disclosure. The method may be performed by a receiving end, such as a data processing apparatus. The apparatus may be implemented by software and/or hardware, may be configured in an electronic device, and typically, may be configured in a mobile phone or a tablet personal computer. The data processing method provided in this embodiment of the present disclosure is suitable for a scenario of processing data sent by a transmitting end. As shown in FIG. 4, the data processing method provided in this embodiment may include:

S301: Receive a current relationship sequence of a current data frame and acquire frame data of the current data frame, where the current relationship sequence is sent by a first transmitting end, includes a current frame identifier of the current data frame and a historical frame identifier of at least one historical data frame, and is used to indicate a current arrangement sequence of the current data frame in a target data stream, and the current data frame and the at least one historical data frame are data frames continuously arranged in the target data stream.

The current data frame may be understood as a data frame that is currently to be processed, such as a data frame with a relationship sequence and or frame data received currently. The current relationship sequence may be understood as a relationship sequence of the current data frame. The current arrangement sequence may be understood as an arrangement sequence of the current data frame in the target data stream. The first transmitting end may be a transmitting end that transmits the current relationship sequence and/or the frame data of the current data frame to the receiving end.

Specifically, the current relationship sequence of the current data frame sent by the first transmitting end may be received, and the frame data of the current data frame is acquired to facilitate the subsequent addition of the frame data of the current data frame to the target data stream, thereby restoring the target data stream.

In some implementations, when the first transmitting end transmits slice data of the current data frame to the receiving end, the slice data of the current data frame may be concatenated into frame data of the current data frame. In this case, optionally, the step of acquiring frame data of the current data frame includes: receiving slice data of the current data frame, where the slice data is sent by the first transmitting end; determining current slice count information of the current data frame according to the current frame identifier; and concatenating the slice data according to the current slice count information and slice sequence number information of the slice data so as to obtain the frame data of the current data frame.

The current slice count information may be understood as slice count information of the current data frame, which may be used to indicate a total slice count of the current data frame. The slice sequence number information of the slice data may be used to indicate which data slice the slice data is in the current data frame.

Exemplarily, the slice data of the current data frame sent by the first transmitting end may be first received; and the current frame identifier of the current data frame is acquired from the current relationship sequence of the current data frame, and the current slice count information of the current data frame is extracted from the current frame identifier. Then, the received slice data of the current data frame is concatenated according to the current slice count information and the slice sequence number information of the received slice data. For example, the received slice data of the current data frame is concatenated in an ascending sequence of the slice sequence number information, to obtain the frame data of the current data frame.

In the above implementation, considering that slice data loss may occur in a data transmission process, whether the slice data sent by the first transmitting end is missing may be determined before and/or during the concatenation of the slice data sent by the first transmitting end, and when the slice data is missing, a second transmitting end is requested for acquiring the missing slice data, thereby ensuring the integrity of the concatenated frame data.

In this case, optionally, before the concatenating the slice data according to the current slice count information and slice sequence number information of the slice data, the method further includes: transmitting, in the case of target slice data of the current data frame being lost, a supplementing request for the target slice data to the second transmitting end, and receiving the target slice data returned by the second transmitting end based on the supplementing request.

Exemplarily, if there is missing target slice data in the current data frame, the supplementing request for the target slice data may be generated and sent to the second transmitting end to request the second transmitting end to transmit the target slice data to the receiving end through the supplementing request. Correspondingly, after receiving the supplementing request sent by the receiving end, the second transmitting end may transmit the target slice data corresponding to the supplementing request to the receiving end. Therefore, the receiving end may receive the target slice data sent by the second transmitting end. The second transmitting end and the first transmitting end may be the same or different transmitting ends, and this embodiment does not impose limitations on this. The target slice data may be understood as slice data that is lost in the current data frame.

S302: Add the frame data of the current data frame to the target data stream based on the current arrangement sequence.

Specifically, based on a current arrangement sequence of the current data frame in the target data stream, as indicated in the relationship sequence of the current data frame, the frame data of the current data frame may be added to a position indicated by the current arrangement sequence in the target data stream. For example, the frame data of the current data frame is added after frame data of a historical data frame adjacent to the current data frame to a position that is indicated in the current relationship sequence, thereby gradually restoring the target data stream.

In some implementations, the frame data of the current data frame may be directly added to the target data stream based on the current arrangement sequence of the current data frame, as indicated by the current relationship sequence, without considering an associated relationship sequence of the current data frame.

In some other implementations, the associated relationship sequence of the current data frame may be considered. When the current arrangement sequence of the current data frame, as indicated by the current relationship sequence, is the same as the associated arrangement sequence of the current data frame, as indicated by the associated relationship sequence, the frame data of the current data frame may be added to the target data stream based on the current arrangement sequence.

In this case, the step of adding the frame data of the current data frame to the target data stream based on the current arrangement sequence includes: adding, based on the current arrangement sequence, the frame data of the current data frame to the target data stream if the current arrangement sequence is the same as the associated arrangement sequence indicated by the associated relationship sequence of the current data frame, where the associated relationship sequence includes a current frame identifier of the current data frame.

The associated relationship sequence of the current data frame may be understood as a relationship sequence that includes the current frame identifier of the current data frame and other data frames except for the current data frame, such as a relationship sequence of one or more data frames after the current data frame in the target data stream. There may be one or more associated relationship sequences of the current data frame. Since the associated relationship sequence of the current data frame also includes the frame identifier of the current data frame, the associated relationship sequence of the current data frame may also indicate the arrangement sequence of the current data frame in the target data stream. The associated arrangement sequence may be understood as an arrangement sequence of the current data frame in the target data stream, as indicated by the associated relationship sequence of the current data frame. The current arrangement sequence and the associated arrangement sequence being the same may be understood in a way that an arrangement position of the current data frame in the target data stream, determined based on the current arrangement sequence is the same as an arrangement position of the current data frame in the target data stream, determined based on the associated arrangement sequence.

Exemplarily, after receiving the current relationship sequence of the current data frame, whether a local terminal has received the associated relationship sequence of the current data frame may be determined. If the local terminal has received the associated relationship sequence of the current data frame, the associated relationship sequence of the current data frame may be acquired. Whether the current arrangement sequence indicated by the current relationship sequence of the current data frame is the same as the associated arrangement sequence indicated by the associated relationship sequence of the current data frame is determined, and when the arrangement sequences indicated by both are the same, the frame data of the current data frame is added to the target data stream based on the current arrangement sequence of the current data frame.

In some implementations, when it is determined that the current arrangement sequence indicated by the current relationship sequence of the current data frame is not the same as the associated arrangement sequence indicated by the associated relationship sequence of the current data frame, the frame data of the current data frame may be added to the target data stream based on an arrangement sequence indicated by a certain relationship sequence in the current relationship sequence and the associated relationship sequence. A method for determining the certain relationship sequence may be set as needed. Exemplarily, the certain relationship sequence may be one of the current relationship sequence of the current data frame and the associated relationship sequence that is first received by the receiving end, namely a target relationship sequence. Therefore, the frame data of the current data frame is added to the target data stream according to the arrangement sequence of the current data frame in the target data stream, as indicated by the target relationship sequence. In this case, optionally, the data processing method provided in this embodiment may also include: adding, based on the target relationship sequence, the frame data of the current data frame to the target data stream if the current arrangement sequence is not the same as the associated arrangement sequence indicated by the associated relationship sequence of the current data frame, where the target relationship sequence is a relationship sequence that is first received between the current relationship sequence and the associated relationship sequence.

Additionally, when it is determined that the local terminal has not yet received the associated relationship sequence of the current data frame, there may be a need to wait until the associated relationship sequence of the current data frame is received; or there is no need to wait, and the frame data of the current data frame is directly added to the target data stream based on the current arrangement sequence indicated by the current relationship sequence, thereby facilitating the receiving end to play the target data stream in time.

According to the data processing method provided in this embodiment, the current relationship sequence of the current data frame is received, and the frame data of the current data frame is acquired, where the current relationship sequence is sent by the first transmitting end, includes the current frame identifier of the current data frame and the historical frame identifier of the at least one historical data frame, and is used to indicate the current arrangement sequence of the current data frame in the target data stream, and the current data frame and the at least one historical data frame are the data frames continuously arranged in the target data stream; and the frame data of the current data frame is added to the target data stream based on the current arrangement sequence. By utilizing the above technical solution in this embodiment, the arrangement sequence of the data frame in the data stream is determined based on the relationship sequence without marking the sequence through the central node, and therefore there is no need to set the central node for marking the sequence, thereby simplifying a P2P-based stream pull method, and improving the disaster recovery capability during stream pull.

FIG. 5 is a schematic diagram of a structure of a data transmission apparatus according to an embodiment of the present disclosure. The apparatus may be configured at a transmitting end. The apparatus may be implemented by software and/or hardware, may be configured in an electronic device, and typically, may be configured in a mobile phone or a tablet personal computer. Data may be sent to a receiving end by performing a data transmission method, such as transmitting data to the receiving end based on P2P. As shown in FIG. 5, the data transmission apparatus provided in this embodiment may include: an acquiring module 501, a generation module 502, and a transmitting module 503.

The acquiring module 501 is configured to acquire a current frame identifier of a current data frame in a target data stream, where the current data frame is a data frame that is currently to be sent.

The generation module 502 is configured to generate a current relationship sequence of the current data frame according to the current frame identifier and a historical frame identifier of at least one historical data frame, where the current data frame and the at least one historical data frame are data frames continuously arranged in the target data stream, and the current relationship sequence is used to indicate a current arrangement sequence of the current data frame in the target data stream.

The transmitting module 503 is configured to transmit frame data of the current data frame and the current relationship sequence to a receiving end.

According to the data transmission apparatus provided in this embodiment, the acquiring module acquires the current frame identifier of the current data frame in the target data stream, where the current data frame is the data frame that is currently to be sent; the generation module generates the current relationship sequence of the current data frame according to the current frame identifier and the historical frame identifier of the at least one historical data frame, where the current data frame and the at least one historical data frame are the data frames continuously arranged in the target data stream, and the current relationship sequence is used to indicate the current arrangement sequence of the current data frame in the target data stream; and the transmitting module transmits the frame data of the current data frame and the current relationship sequence to the receiving end. By utilizing the above technical solution in this embodiment, when the frame data of the data frame is sent to the receiving end, the relationship sequence of the data frame is further sent and indicates the arrangement sequence of the data frame in the data stream without marking the sequence through the central node, and therefore there is no need to set the central node for marking the sequence, thereby simplifying a P2P-based stream pull method, and improving the disaster recovery capability during stream pull.

Optionally, the acquiring module 501 may include: an information acquiring unit, configured to acquire current frame header information of the current data frame in the target data stream; and an identifier generation unit, configured to generate a current frame identifier of the current data frame according to the current frame header information.

Optionally, the identifier generation unit may be configured to: extract current decode time stamp information of the current data frame from the current frame header information, and determine a current cyclical redundancy check code of the current data frame according to the current frame header information; and generate a current frame identifier of the current data frame based on the current decode time stamp information, the current cyclical redundancy check code, and current slice count information of the current data frame.

Optionally, the identifier generation unit may be configured to: determine a cyclical redundancy check code of the current data frame according to the current frame header information and historical frame header information of the at least one historical data frame.

Optionally, the target data stream includes at least two data substreams, and the different data substreams are transmitted to the receiving end via different transmitting ends.

Optionally, a data substream corresponding to the current data frame is determined based on the decode time stamp information of the current data frame.

Further, the data transmission apparatus provided in this embodiment may also include: a slice module, configured to use a preset slice method to slice the frame data of the current data frame to obtain slice data of the current data frame before the transmitting frame data of the current data frame and the current relationship sequence to a receiving end, where the preset slice method is a slice method shared by different transmitting ends; and the transmitting module 503 may be configured to transmit the slice data of the current data frame and the current relationship sequence to the receiving end.

The data transmission apparatus provided in this embodiment of the present disclosure may perform the data transmission method provided in any embodiment of the present disclosure, and has the corresponding functional modules and beneficial effects for performing the data transmission method. For technical details that are not described in detail in this embodiment, reference may be made to the data transmission method provided in any embodiment of the present disclosure.

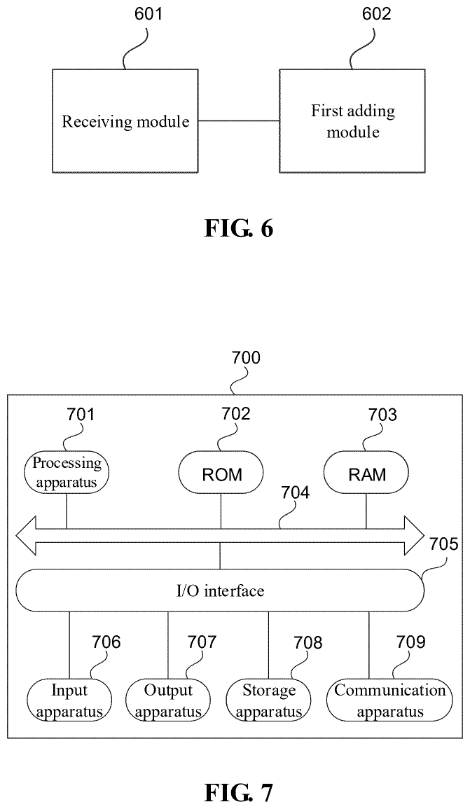

FIG. 6 is a block diagram of a structure of a data processing apparatus according to an embodiment of the present disclosure. The apparatus may be configured at a receiving end. The apparatus may be implemented by software and/or hardware, may be configured in an electronic device, and typically, may be configured in a mobile phone or a tablet personal computer. Data sent by a transmitting end may be processed by performing a data processing method. As shown in FIG. 6, the data processing apparatus provided in this embodiment may include a receiving module 601 and a first adding module 602.

The receiving module 601 is configured to receive a current relationship sequence of a current data frame and acquire frame data of the current data frame, where the current relationship sequence is sent by a first transmitting end, includes a current frame identifier of the current data frame and a historical frame identifier of at least one historical data frame, and is used to indicate a current arrangement sequence of the current data frame in a target data stream, and the current data frame and the at least one historical data frame are data frames continuously arranged in the target data stream; and
a first adding module 602, configured to add the frame data of the current data frame to the target data stream based on the current arrangement sequence.

According to the data processing apparatus provided in this embodiment, the receiving module receives the current relationship sequence of the current data frame and acquires the frame data of the current data frame, where the current relationship sequence is sent by the first transmitting end, includes the current frame identifier of the current data frame and the historical frame identifier of the at least one historical data frame, and is used to indicate the current arrangement sequence of the current data frame in the target data stream, and the current data frame and the at least one historical data frame are the data frames continuously arranged in the target data stream; and the first adding module adds the frame data of the current data frame to the target data stream based on the current arrangement sequence. By utilizing the above technical solution in this embodiment, the arrangement sequence of the data frame in the data stream is determined based on the relationship sequence without marking the sequence through the central node, and therefore there is no need to set the central node for marking the sequence, thereby simplifying a P2P-based stream pull method, and improving the disaster recovery capability during stream pull.

Optionally, the receiving module 601 may include: a receiving unit, configured to receive slice data of the current data frame, where the slice data is sent by the first transmitting end; an information determining unit, configured to determine current slice count information of the current data frame according to the current frame identifier; and a concatenation unit, configured to concatenate the slice data according to the current slice count information and slice sequence number information of the slice data so as to obtain frame data of the current data frame.

Further, the data processing apparatus provided in this embodiment may also include a supplementing module, configured to transmit, in the case of target slice data of the current data frame being lost, a supplementing request for the target slice data to a second transmitting end before the concatenating the slice data according to the current slice count information and slice sequence number information of the slice data, and receive the target slice data returned by the second transmitting end based on the supplementing request.

Optionally, the first adding module 602 is configured to: add, based on the current arrangement sequence, the frame data of the current data frame to the target data stream if the current arrangement sequence is the same as an associated arrangement sequence indicated by an associated relationship sequence of the current data frame, where the associated relationship sequence includes a current frame identifier of the current data frame.

Further, the data processing apparatus provided in this embodiment may also include: a second adding module, configured to add, based on a target relationship sequence, the frame data of the current data frame to the target data stream if the current arrangement sequence is not the same as an associated arrangement sequence indicated by the associated relationship sequence of the current data frame, where the target relationship sequence is a relationship sequence that is first received between the current relationship sequence and the associated relationship sequence.

The data processing apparatus provided in this embodiment of the present disclosure may perform the data processing method provided in any embodiment of the present disclosure, and has the corresponding functional modules and beneficial effects for performing the data processing method. For technical details that are not described in detail in this embodiment, reference may be made to the data processing method provided in any embodiment of the present disclosure.

Referring to FIG. 7 below, FIG. 7 illustrates a schematic diagram of a structure of an electronic device (e.g., a terminal device) 700 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a portable Android device (PAD), a portable media player (PMP), and a vehicle-mounted terminal (e.g., a vehicle navigation terminal), and fixed terminals such as a digital TV and a desktop computer. The electronic device shown in FIG. 7 is merely an example, and should not impose any limitation on the function and scope of use of the embodiments of the present disclosure.

As shown in FIG. 7, the electronic device 700 may include a processing apparatus (e.g., a central processing unit and a graphics processing unit) 701, which may perform various appropriate actions and processing according to a program stored on a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to one another through a bus 704. An input/output (I/O) interface 705 is also connected to the bus 704.

Typically, the following apparatuses may be connected to the I/O interface 705: an input apparatus 706 including, for example, a touch screen, a touch pad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a magnetic tape and a hard drive; and a communication apparatus 709. The communication apparatus 709 may allow the electronic device 700 to be in wireless or wired communication with other devices for data exchange. Although FIG. 7 illustrates the electronic device 700 with various apparatuses, it should be understood that it is not necessary to implement or have all the shown apparatuses. It may be an alternative to implement or have more or fewer apparatuses.

In particular, the above process described with reference to the flowcharts according to the embodiments of the present disclosure may be implemented as a computer software program. For example, an embodiment of the present disclosure includes a computer program product, which includes a computer program carried on a non-transitory computer-readable medium, where the computer program includes program code used to perform the method shown in the flowchart. In this embodiment, the computer program may be downloaded and installed from the network through the communication apparatus 709, installed from the storage apparatus 708, or installed from the ROM 702. The computer program, when executed by the processing apparatus 701, performs the above functions limited in the method in this embodiment of the present disclosure.

It should be noted that the above computer-readable medium in the present disclosure may be either a computer-readable signal medium or a computer-readable storage medium, or any combination of the two. The computer-readable storage medium may be, for example, but is not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above. In the present disclosure, the computer-readable storage medium may be any tangible medium including or storing a program, and the program may be for use by or for use in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program for use by or for use in combination with the instruction execution system, apparatus, or device. The program code included in the computer-readable medium may be transmitted by any suitable medium, including but not limited to a wire, an optical cable, radio frequency (RF), etc., or any suitable combination of the above.

In some implementations, a client and a server may communicate using any currently known or future-developed network protocols such as a hypertext transfer protocol (HTTP), and may be interconnected with digital data communication in any form or medium (e.g., a communication network). Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The above computer-readable medium may be included in the above electronic device; or may also separately exist without being assembled in the electronic device.

The above computer-readable medium carries one or more programs. The above one or more programs, when executed by the electronic device, cause the electronic device to: acquire a current frame identifier of a current data frame in a target data stream, where the current data frame is a data frame that is currently to be sent; generate a current relationship sequence of the current data frame according to the current frame identifier and a historical frame identifier of at least one historical data frame, where the current data frame and the at least one historical data frame are data frames continuously arranged in the target data stream, and the current relationship sequence is used to indicate a current arrangement sequence of the current data frame in the target data stream; and transmit frame data of the current data frame and the current relationship sequence to a receiving end; alternatively,
to receive a current relationship sequence of a current data frame and acquire frame data of the current data frame, where the current relationship sequence is sent by a first transmitting end, includes a current frame identifier of the current data frame and a historical frame identifier of at least one historical data frame, and is used to indicate a current arrangement sequence of the current data frame in a target data stream, and the current data frame and the at least one historical data frame are data frames continuously arranged in the target data stream; and add the frame data of the current data frame to the target data stream based on the current arrangement sequence.

Computer program code for performing operations of the present disclosure may be written in one or more programming languages or a combination thereof, where the above programming languages include, but are not limited to, object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a local area network (LAN) or a wide area network (WAN), or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented by using a dedicated hardware-based system that performs specified functions or operations, or may be implemented by using a combination of dedicated hardware and computer instructions.

The related units described in the embodiments of the present disclosure may be implemented by software or hardware. The name of the module does not limit the module itself in certain cases.

Herein, the functions described above may be at least partially executed by one or more hardware logic components. For example, without limitation, exemplary hardware logic components that can be used include: a field-programmable gate array (FPGA), an application specific integrated circuit (ASIC), an application specific standard part (ASSP), a system on chip (SOC), a complex programmable logic device (CPLD), etc.

In the context of the present disclosure, a machine-readable medium may be a tangible medium that may include or store a program for use by or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above content.

According to one or more embodiments of the present disclosure, Example 1 provides a data transmission method, applied to a transmitting end, where the method includes:
acquiring a current frame identifier of a current data frame in a target data stream, where the current data frame is a data frame that is currently to be sent;
generating a current relationship sequence of the current data frame according to the current frame identifier and a historical frame identifier of at least one historical data frame, where the current data frame and the at least one historical data frame are data frames continuously arranged in the target data stream, and the current relationship sequence is used to indicate a current arrangement sequence of the current data frame in the target data stream; and
transmitting frame data of the current data frame and the current relationship sequence to a receiving end.

According to one or more embodiments of the present disclosure, Example 2 provides the method according to Example 1, where the acquiring a current frame identifier of a current data frame in a target data stream includes:
acquiring current frame header information of the current data frame in the target data stream; and
generating the current frame identifier of the current data frame according to the current frame header information.

According to one or more embodiments of the present disclosure, Example 3 provides the method according to Example 2, where the generating the current frame identifier of the current data frame according to the current frame header information includes:
extracting current decode time stamp information of the current data frame from the current frame header information, and determining a current cyclical redundancy check code of the current data frame according to the current frame header information; and
generating the current frame identifier of the current data frame based on the current decode time stamp information, the current cyclical redundancy check code, and current slice count information of the current data frame.

According to one or more embodiments of the present disclosure, Example 4 provides the method according to Example 3, where the determining a cyclical redundancy check code of the current data frame according to the current frame header information includes:
determining the cyclical redundancy check code of the current data frame according to the current frame header information and historical frame header information of the at least one historical data frame.

According to one or more embodiments of the present disclosure, Example 5 provides the method according to Example 1, where the target data stream includes at least two data substreams, and the different data substreams are transmitted to the receiving end via different transmitting ends.

According to one or more embodiments of the present disclosure, Example 6 provides the method according to Example 5, where a data substream corresponding to the current data frame is determined based on the decode time stamp information of the current data frame.

According to one or more embodiments of the present disclosure, Example 7 provides the method according to any one of Examples 1 to 6, where before the transmitting frame data of the current data frame and the current relationship sequence to a receiving end, the method further includes:
using a preset slice method to slice the frame data of the current data frame to obtain slice data of the current data frame, where the preset slice method is a slice method shared by different transmitting ends; and
the transmitting frame data of the current data frame and the current relationship sequence to a receiving end includes:
transmitting the slice data of the current data frame and the current relationship sequence to the receiving end.

According to one or more embodiments of the present disclosure, Example 8 provides a data processing method, applied to a receiving end, where the method includes:
receiving a current relationship sequence of a current data frame and acquiring frame data of the current data frame, where the current relationship sequence is sent by a first transmitting end, includes a current frame identifier of the current data frame and a historical frame identifier of at least one historical data frame, and is used to indicate a current arrangement sequence of the current data frame in a target data stream, and the current data frame and the at least one historical data frame are data frames continuously arranged in the target data stream; and
adding the frame data of the current data frame to the target data stream based on the current arrangement sequence.

According to one or more embodiments of the present disclosure, Example 9 provides the method according to Example 8, where the acquiring frame data of the current data frame includes:
receiving slice data of the current data frame, where the slice data is sent by the first transmitting end;
determining current slice count information of the current data frame according to the current frame identifier; and
concatenating the slice data according to the current slice count information and slice sequence number information of the slice data so as to obtain the frame data of the current data frame.

According to one or more embodiments of the present disclosure, Example 10 provides the method according to Example 9, where before the concatenating the slice data according to the current slice count information and slice sequence number information of the slice data, the method further includes:
transmitting, in the case of target slice data of the current data frame being lost, a supplementing request for the target slice data to a second transmitting end, and receiving the target slice data returned by the second transmitting end based on the supplementing request.

According to one or more embodiments of the present disclosure, Example 11 provides the method according to any one of Examples 8 to 10, where the adding the frame data of the current data frame to the target data stream based on the current arrangement sequence includes:
adding, based on the current arrangement sequence, the frame data of the current data frame to the target data stream if the current arrangement sequence is the same as an associated arrangement sequence indicated by an associated relationship sequence of the current data frame, where the associated relationship sequence includes a current frame identifier of the current data frame.

According to one or more embodiments of the present disclosure, Example 12 provides the method according to Example 11, further including:
adding, based on a target relationship sequence, the frame data of the current data frame to the target data stream if the current arrangement sequence is not the same as an associated arrangement sequence indicated by an associated relationship sequence of the current data frame, where the target relationship sequence is a relationship sequence that is first received between the current relationship sequence and the associated relationship sequence.

According to one or more embodiments of the present disclosure, Example 13 provides a data transmission apparatus, applied to a transmitting end, where the apparatus includes:
an acquiring module, configured to acquire a current frame identifier of a current data frame in a target data stream, where the current data frame is a data frame that is currently to be sent;
a generation module, configured to generate a current relationship sequence of the current data frame according to the current frame identifier and a historical frame identifier of at least one historical data frame, where the current data frame and the at least one historical data frame are data frames continuously arranged in the target data stream, and the current relationship sequence is used to indicate a current arrangement sequence of the current data frame in the target data stream; and
a transmitting module, configured to transmit frame data of the current data frame and the current relationship sequence to a receiving end.

According to one or more embodiments of the present disclosure, Example 14 provides a data processing apparatus, configured at a receiving end, where the apparatus includes:
a receiving module, configured to receive a current relationship sequence of a current data frame and acquire frame data of the current data frame, where the current relationship sequence is sent by a first transmitting end and includes a current frame identifier of the current data frame and a historical frame identifier of at least one historical data frame, the current relationship sequence is used to indicate a current arrangement sequence of the current data frame in a target data stream, and the current data frame and the at least one historical data frame are data frames continuously arranged in the target data stream; and
a first adding module, configured to add the frame data of the current data frame to the target data stream based on the current arrangement sequence.

According to one or more embodiments of the present disclosure, Example 15 provides an electronic device, including:
one or more processors; and
a memory, configured to store one or more programs, where
the one or more programs, when executed by the one or more processors, cause the one or more processors to implement the data transmission method according to any one of Examples 1 to 7 or the data processing method according to any one of Examples 8 to 12.

According to one or more embodiments of the present disclosure, Example 16 provides a computer-readable storage medium, storing a computer program, where the program, when executed by a processor, implements the data transmission method according to any one of Examples 1 to 7 or the data processing method according to any one of Examples 8 to 12.

What are described above are only preferred embodiments of the present disclosure and explanations of the technical principles applied. Those skilled in the art should understand that the scope of the disclosure involved in the present disclosure is not limited to the technical solutions formed by specific combinations of the above technical features, and shall also cover other technical solutions formed by any combination of the above technical features or equivalent features thereof without departing from the above concept of disclosure, such as a technical solution formed by replacing the above features with the technical features with similar functions disclosed (but not limited to) in the present disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the present disclosure. Some features that are described in the context of separate embodiments may also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logic actions of the method, it should be understood that the subject matter defined in the appended claims is not necessarily limited to the specific features or actions described above. On the contrary, the specific features and the actions described above are merely example forms for implementing the claims.

I/We claim:

1. A data transmission method, applied to a transmitting end, the method comprising:
acquiring a current frame identifier of a current data frame in a target data stream, wherein the current data frame is a data frame to be transmitted currently;
generating a current relationship sequence of the current data frame according to the current frame identifier and a historical frame identifier of at least one historical data frame, wherein the current data frame and the at least one historical data frame are data frames continuously arranged in the target data stream, and the current relationship sequence is used to indicate a current arrangement sequence of the current data frame in the target data stream; and
transmitting frame data of the current data frame and the current relationship sequence to a receiving end.

2. The method according to claim 1, wherein acquiring the current frame identifier of the current data frame in the target data stream comprises:
acquiring current frame header information of the current data frame in the target data stream; and
generating the current frame identifier of the current data frame according to the current frame header information.

3. The method according to claim 2, wherein generating the current frame identifier of the current data frame according to the current frame header information comprises:
extracting current decode time stamp information of the current data frame from the current frame header information, and determining a current cyclical redundancy check code of the current data frame according to the current frame header information; and
generating the current frame identifier of the current data frame based on the current decode time stamp information, the current cyclical redundancy check code, and current slice count information of the current data frame.

4. The method according to claim 3, wherein determining the cyclical redundancy check code of the current data frame according to the current frame header information comprises:
determining the cyclical redundancy check code of the current data frame according to the current frame header information and historical frame header information of the at least one historical data frame.

5. The method according to claim 1, wherein the target data stream comprises at least two data substreams, and the different data substreams are transmitted to the receiving end by different transmitting ends.

6. The method according to claim 5, wherein a data sub-stream corresponding to the current data frame is determined based on a decode time stamp information of the current data frame.

7. The method according to claim 1, further comprising, before transmitting the frame data of the current data frame and the current relationship sequence to the receiving end:
using a preset slice method to slice the frame data of the current data frame to obtain slice data of the current data frame, wherein the preset slice method is a slice method shared by different transmitting ends; and
transmitting the frame data of the current data frame and the current relationship sequence to the receiving end comprises:
transmitting the slice data of the current data frame and the current relationship sequence to the receiving end.

8. A data processing method, applied to a receiving end, the method comprising:
receiving a current relationship sequence of a current data frame and acquiring frame data of the current data frame, wherein the current relationship sequence is transmitted by a first transmitting end, the current relationship sequence includes a current frame identifier of the current data frame and a historical frame identifier of at least one historical data frame, the current relationship sequence is used to indicate a current arrangement sequence of the current data frame in a target data stream, and the current data frame and the at least one historical data frame are data frames continuously arranged in the target data stream; and
adding the frame data of the current data frame into the target data stream based on the current arrangement sequence.

9. The method according to claim 8, wherein acquiring the frame data of the current data frame comprises:
receiving slice data of the current data frame, wherein the slice data is transmitted by the first transmitting end;
determining current slice count information of the current data frame according to the current frame identifier; and
concatenating the slice data according to the current slice count information and slice sequence number information of the slice data to obtain the frame data of the current data frame.

10. The method according to claim 9, further comprising, before concatenating the slice data according to the current slice count information and the slice sequence number information of the slice data:
transmitting, in response to target slice data of the current data frame being lost, a supplementing request for the target slice data to a second transmitting end, and receiving the target slice data returned by the second transmitting end based on the supplementing request.

11. The method according to claim 8, wherein adding the frame data of the current data frame to the target data stream based on the current arrangement sequence comprises:
adding, based on the current arrangement sequence, the frame data of the current data frame to the target data stream in response to the current arrangement sequence being the same as an associated arrangement sequence indicated by an associated relationship sequence of the current data frame, wherein the associated relationship sequence comprises a current frame identifier of the current data frame.

12. The method according to claim 11, further comprising:
adding, based on a target relationship sequence, the frame data of the current data frame to the target data stream in response to the current arrangement sequence being not the same as the associated arrangement sequence indicated by the associated relationship sequence of the current data frame, wherein the target relationship sequence is a relationship sequence that is first received between the current relationship sequence and the associated relationship sequence.

13. An electronic device, comprising:
at least one processor; and
a memory which is in communication connection with the at least one processor, wherein the memory stores a computer program executable by the at least one processor, and the computer program, when executed by the at least one processor, causes the at least one processor to:
acquire a current frame identifier of a current data frame in a target data stream, wherein the current data frame is a data frame to be transmitted currently;
generate a current relationship sequence of the current data frame according to the current frame identifier and a historical frame identifier of at least one historical data frame, wherein the current data frame and the at least one historical data frame are data frames continuously arranged in the target data stream, and the current relationship sequence is used to indicate a current arrangement sequence of the current data frame in the target data stream; and
transmit frame data of the current data frame and the current relationship sequence to a receiving end.

14. The electronic device according to claim 13, wherein the computer program causing the at least one processor to acquire the current frame identifier of the current data frame in the target data stream further causes the at least one processor to:
acquire current frame header information of the current data frame in the target data stream; and
generate the current frame identifier of the current data frame according to the current frame header information.

15. The electronic device according to claim 14, wherein the computer program causing the at least one processor to generate the current frame identifier of the current data frame according to the current frame header information further causes the at least one processor to:
extract current decode time stamp information of the current data frame from the current frame header information, and determine a current cyclical redundancy check code of the current data frame according to the current frame header information; and
generate the current frame identifier of the current data frame based on the current decode time stamp information, the current cyclical redundancy check code, and current slice count information of the current data frame.

16. The electronic device according to claim 15, wherein the computer program causing the at least one processor to determine the cyclical redundancy check code of the current data frame according to the current frame header information further causes the at least one processor to:
determine the cyclical redundancy check code of the current data frame according to the current frame header information and historical frame header information of the at least one historical data frame.

17. The electronic device according to claim 13, wherein the target data stream comprises at least two data substreams, and the different data substreams are transmitted to the receiving end by different transmitting ends.

18. The electronic device according to claim 17, wherein a data sub-stream corresponding to the current data frame is determined based on a decode time stamp information of the current data frame.

19. The electronic device according to claim 13, the computer program further causes the at least one processor to, before transmitting the frame data of the current data frame and the current relationship sequence to the receiving end:
use a preset slice method to slice the frame data of the current data frame to obtain slice data of the current data frame, wherein the preset slice method is a slice method shared by different transmitting ends; and
transmit the frame data of the current data frame and the current relationship sequence to the receiving end comprises:
transmit the slice data of the current data frame and the current relationship sequence to the receiving end.
